(19) United States
(12) Patent Application Publication
(10) Pub. No.: US 2025/0073761 A1
(43) Pub. Date: Mar. 6, 2025

(54) INTEGRATED FLUID DISTRIBUTOR

(71) Applicants: HYUNDAI MOTOR COMPANY, Seoul (KR); KIA CORPORATION, Seoul (KR); DONG HEE INDUSTRIAL CO., LTD., Ulsan (KR)

(72) Inventors: Seong Cheol Cho, Seoul (KR); Sung Won Lee, Hwaseong-si (KR); Chul Young Choi, Suwon-si (KR); Kun Su Hwang, Incheon (KR); Kyun Bum Park, Hwaseong-si (KR)

(73) Assignees: HYUNDAI MOTOR COMPANY, Seoul (KR); KIA CORPORATION, Seoul (KR); DONG HEE INDUSTRIAL CO., LTD., Ulsan (KR)

(21) Appl. No.: 18/413,535

(22) Filed: Jan. 16, 2024

(30) Foreign Application Priority Data
Sep. 4, 2023 (KR) 10-2023-0117277

(51) Int. Cl. B08B 7/04; B05B 1/30; B05B 15/55; B08B 7/00

(52) U.S. Cl. CPC B08B 7/04; B05B 1/3053; B05B 15/557; B08B 7/0071; B08B 13/00

(57) ABSTRACT

An integrated fluid distributor includes a single case in which flow paths for different fluids are independently disposed. The integrated fluid distributor may also be capable of distributing and discharging respective fluids. The integrated fluid distributor includes a case, and a first flow path disposed within the case. The first flow path has a first inlet, a plurality of first outlets, and a plurality of first valves for a first fluid. The integrated fluid distributor also includes a second flow path disposed independently of the first flow path within the case. The second flow path has a second inlet, a plurality of second outlets, and a plurality of second valves for a second fluid.

### CROSS-REFERENCE TO RELATED APPLICATION(S)

This application claims the benefit of and priority to Korean Patent Application No. 10-2023-0117277 filed on Sep. 4, 2023, the disclosure of which is incorporated herein by reference in its entirety.

### TECHNICAL FIELD

The present disclosure relates to an integrated fluid distributor including a single case in which flow paths for different fluids are independently disposed. The integrated fluid distributor is capable of distributing and discharging respective fluids.

### BACKGROUND

Vehicles are equipped with various types of sensors (camera, radar, lidar, and the like) to increase safety and convenience. Sensors may not operate normally if foreign substances get onto the surfaces of the sensors. The sensors that do not operate normally as described above may compromise driving safety, so it may be necessary to clean the sensors.

In order to clean the sensors mounted on a vehicle, a cleaning system for spraying high-pressure fluids such as air and a cleaning liquid using a nozzle has been applied to the vehicle. However, as an apparatus for spraying air and an apparatus for spraying a cleaning liquid are configured separately from each other, the overall cleaning system requires a large number of parts, thereby increasing the complexity of the overall cleaning system. Due to the complexity of the cleaning system, assembling and maintaining the system may not be easily performed.

Furthermore, a conventional cleaning system may include a plurality of distributors for air and a plurality of distributors for a cleaning liquid that are separate from each other, thus leading to an excessive increase in the layout of the overall cleaning system. This may make it difficult to mount the cleaning system on the vehicle. Additionally, the increase in volume and weight of the cleaning system may increase the cost, thereby reducing product competitiveness.

The statements in this Background section merely provide background information related to the present disclosure and may not constitute prior art.

### SUMMARY

An aspect of the present disclosure provides an integrated fluid distributor including a single case in which flow paths for different fluids are independently disposed. The integrated fluid distributor is capable of distributing and discharging respective fluids.

According to an aspect of the present disclosure, there is provided an integrated fluid distributor including a case, and a first flow path disposed within the case. The first flow path includes a first inlet, a plurality of first outlets, and a plurality of first valves for a first fluid. The integrated fluid distributor also includes a second flow path disposed independently of the first flow path within the case. The second flow path includes a second inlet, a plurality of second outlets, and a plurality of second valves for a second fluid.

Each first valve may be configured to open or close a branch point of each first outlet branching from the first flow path. Each second valve may be configured to open or close a branch point of each second outlet branching from the second flow path.

The case may include a body portion accommodating the plurality of first valves and the plurality of second valves. The case may also include a manifold coupled to one side of the body portion. The first flow path and the second flow path may be formed in the manifold.

The body portion may have a plurality of valve accommodation holes arranged in two rows in a lengthwise direction of the body portion. The plurality of valve accommodation holes in one row may respectively accommodate the plurality of first valves and communicate with the first flow path. The plurality of valve accommodation holes in another row may respectively accommodate the plurality of second valves and communicate with the second flow path.

The first inlet and the plurality of first outlets may extend from the manifold to be parallel to a heightwise direction of the body portion. The second inlet may extend from the manifold to be parallel to a lengthwise direction of the body portion. The plurality of second outlets may extend from the manifold to be parallel to a widthwise direction of the body portion.

The first inlet may further include an inlet valve configured to control a flow of the first fluid within the first flow path.

The inlet valve, the plurality of first valves, and the plurality of second valves may be solenoid valves having the same configuration.

Each solenoid valve may include a valve body, a plurality of first holes disposed in one side of the valve body, and a second hole formed to protrude from the one side of the valve body. Each solenoid valve may also include a valve flow path formed within the valve body. The valve flow path may be configured to connect the plurality of first holes and the second hole to each other. Each solenoid valve may also include a plunger configured to move by electromagnetic force generated when power is applied. The plunger may be configured to regulate the valve flow path.

In the first flow path, a duct flow path may be formed between the inlet valve and a first valve positioned upstream the first flow path. An auxiliary tube may be provided within the duct flow path.

When the inlet valve is the solenoid valve, one of the plurality of first holes may be aligned with the first inlet and may be configured to be in fluid communication with the first inlet, and the second hole may be aligned with an inlet of the auxiliary tube and may be configured to be in fluid communication with the inlet.

When the plurality of first valves are the solenoid valves, the plurality of first holes of each solenoid valve may be in fluid communication with the first flow path, and the second hole of each solenoid valve may be aligned with each first outlet and may be configured to be in fluid communication with each first outlet.

When the plurality of second valves are the solenoid valves, the plurality of first holes of each solenoid valve may be in fluid communication with the second flow path, and the second hole of each solenoid valve may be configured to be in fluid communication with each second outlet.

The body portion may have a sensor accommodation hole disposed in one side thereof. At least one fluid sensor may be accommodated in the sensor accommodation hole.

The first flow path may include a sensing flow path configured to allow the first inlet and the sensor accommodation hole to communicate with each other.

The fluid sensor may be a pressure sensor. The pressure sensor may measure a pressure of the first fluid flowing into the sensor accommodation hole through the sensing flow path.

The integrated fluid distributor may further include a control board disposed on the body portion. The control board may be electrically connected to the fluid sensor, the inlet valve, the plurality of first valves, and the plurality of second valves to receive information from the fluid sensor and to control operation of the inlet valve, the plurality of first valves, and the plurality of second valves.

The integrated fluid distributor may further include a heating member disposed in at least one of the first flow path and the second flow path. The heating member may include a heating wire.

The integrated fluid distributor may be applied to a cleaning system for cleaning a vehicle sensor mounted on a vehicle. The cleaning system may include an air supply module configured to supply compressed air, and a cleaning liquid supply module configured to supply a cleaning liquid. The integrated fluid distributor may be configured to be in fluid connection with the air supply module and the cleaning liquid supply module.

The air supply module may include an air compressor configured to generate compressed air, and an air tank configured to store the compressed air. The cleaning liquid supply module may include a cleaning liquid tank configured to store a cleaning liquid, and a pump configured to supply the cleaning liquid stored in the cleaning liquid tank to the integrated fluid distributor. The air tank may be configured to be in fluid connection with the first inlet, such that compressed air, a first fluid, or a combination thereof may be distributed in the first flow path. The pump may be configured to be in fluid connection with the second inlet, such that a cleaning liquid, a second fluid, or a combination thereof may be distributed in the second flow path.

The integrated fluid distributor may form a module integrated with or an assembly integrally assembled with at least one of the air supply module and the cleaning liquid supply module.

According to example embodiments of the present disclosure, flow paths for different fluids may be independently disposed in a single distributor. As a result, the configuration of a single distributor reduces the number of parts, as compared to distributors configured for each flow path, and reduces the possibility of leakage and energy loss due to a simplified pipe.

In addition, according to example embodiments of the present disclosure, a configuration of a single distributor in which flow paths for fluids are independently disposed may allow the number of modules within an application system to be optimized, and may reduce a layout, a volume, and a weight of the system, as well as costs. As a result, the configuration of a single distributor increases product competitiveness.

### BRIEF DESCRIPTION OF DRAWINGS

The above and other aspects, features, and advantages of the present disclosure should be more clearly understood from the following detailed description, in taken conjunction with the accompanying drawings, in which:

FIG. 1 is a perspective view of an integrated fluid distributor according to a first example embodiment of the present disclosure;

FIG. 2 is an exploded perspective view of FIG. 1;

FIG. 3 is a bottom view of a manifold;

FIG. 4 is a cross-sectional view of the arrangement of a first valve and a fluid sensor;

FIGS. 5 to 9 are diagrams illustrating an operation of an integrated fluid distributor according to a first example embodiment of the present disclosure;

FIG. 10 is an exploded perspective view of an integrated fluid distributor according to a second example embodiment of the present disclosure; and

FIG. 11 is a schematic diagram illustrating an example of a cleaning system for a vehicle sensor to which an integrated fluid distributor is applied according to example embodiments of the present disclosure.

### DETAILED DESCRIPTION

Hereinafter, the present disclosure is described in detail with reference to exemplary drawings. In adding reference numerals to components of each drawing, it should be noted that the same components are indicated by the same numerals even though displayed on different drawings.

The terms “first,” “second,” and the like may be used to describe various components. However, the terms do not limit a sequence, size, importance, and the like of components, and are used only to distinguish a component from another component.

When a component, device, element, or the like of the present disclosure is described as having a purpose or performing an operation, function, or the like, the component, device, or element should be considered herein as being “configured to” meet that purpose or perform that operation or function.

For ease of understanding the description, an embodiment of an application is described in which an integrated fluid distributor according to the present disclosure is applied to a cleaning system for a sensor installed in a vehicle. However, the embodiment is not necessarily limited thereto.

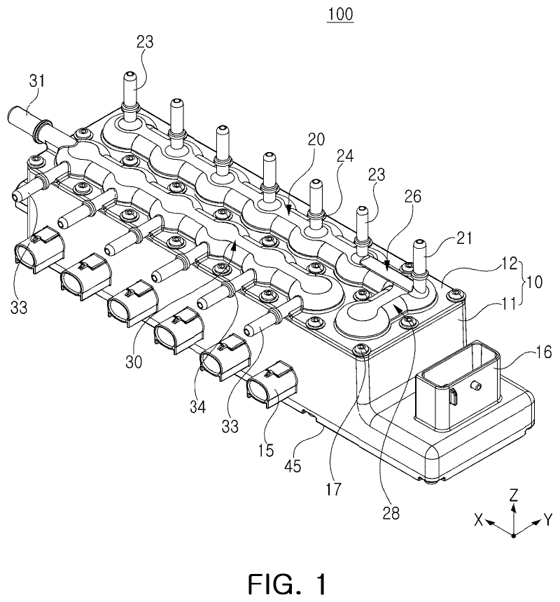

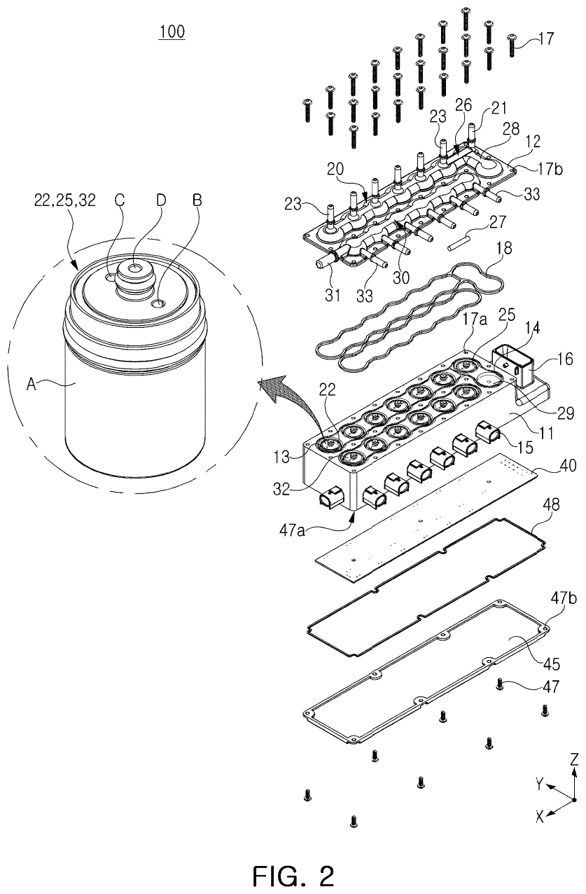

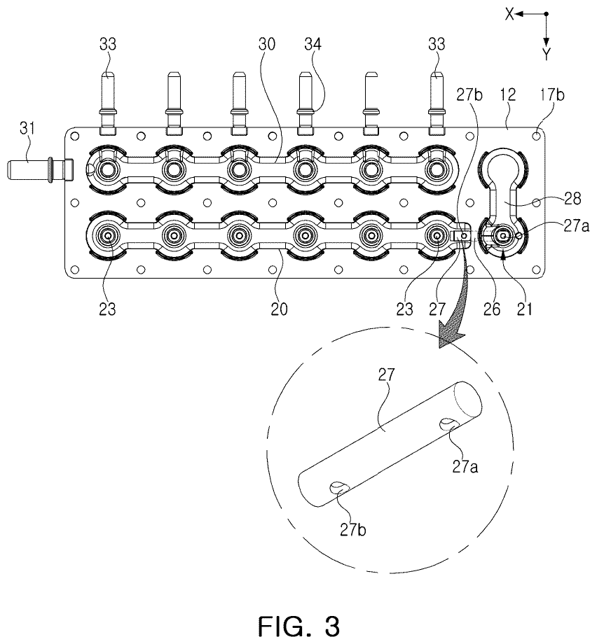

FIG. 1 is a perspective view of an integrated fluid distributor according to a first embodiment of the present disclosure. FIG. 2 is an exploded perspective view of FIG. 1. FIG. 3 is a bottom view of a manifold.

As illustrated in FIGS. 1 to 3, an integrated fluid distributor 100 according to the first example embodiment of the present disclosure may include a case 10, a first flow path 20, and a second flow path 30.

The case 10 may include a body portion 11 accommodating a plurality of valves 22 and 32, and a manifold 12 coupled to one side of the body portion. A first flow path 20 and a second flow path 30 are formed in the manifold 12.

The body portion 11 may be formed, for example, as a single member having a substantially rectangular parallelepiped block shape. The body portion 11 may be manufactured, for example, using injection molding or sintering molding.

The body portion 11 may have a plurality of valve accommodation holes 13 formed to extend in a heightwise direction (i.e., Z-direction or height direction) of the body portion and arranged in two rows in a lengthwise direction (i.e., longitudinal direction or X-direction). At least one sensor accommodation hole 14 is disposed on one side of the body portion in the lengthwise direction (i.e., longitudinal direction or X-direction). For example, as illustrated in FIGS. 1 and 2, thirteen valve accommodation holes 13 and one sensor accommodation hole 14 may be formed. However, the number and arrangement of the valve accommodation holes and the sensor accommodation holes are not necessarily limited to the examples described above and illustrated.

A first valve 22 or a second valve 32 may be press-fitted into and accommodated in each valve accommodation hole 13. As a result, the first valves 22 and the second valves 32 are completely and firmly fixed within the body portion 11, thereby preventing noise caused by vibrations.

At least one fluid sensor 29 may be press-fitted into and accommodated in the sensor accommodation hole 14. For example, a fluid sensor 29, such as a pressure sensor, a temperature sensor, a flow sensor, or the like, may be accommodated solely or in combination.

In addition, at least some of the valve accommodation holes 13 may communicate with at least one connection hole 15 formed in a lateral direction of the body portion 11, for example, in a widthwise direction (i.e., lateral direction or Y-direction) or the lengthwise direction (i.e., longitudinal direction or X-direction). A power line or signal line may be connected to a corresponding valve through the connection hole 15.

The body portion 11 may further include a connector mounting portion 16 formed on one side thereof in the lengthwise direction (i.e., longitudinal direction or X-direction) to be stepped. The connector mounting portion 16 has a through-hole (not illustrated). A connector (not illustrated) to which the power line or signal line is connected may be installed in the connector mounting portion 16, and power may be applied or a control signal may be transmitted to a control board 40 to be described below by the connector.

The manifold 12 may be formed, for example, as a substantially plate-shaped member having a predetermined thickness. The manifold may be manufactured, for example, using injection molding or sintering molding.

The manifold 12 may be coupled to one side of the body portion 11 by a plurality of fasteners 17, such as screws. When the fasteners 17 are screws, a plurality of fastening holes 17b may be formed in the manifold. In the body portion, a screw hole 17a may be formed in a position corresponding to that of each fastening hole. The screw may pass through the manifold 12 and be screwed into the screw hole 17a of the body portion 11. As a result, the manifold 12 and the body portion 11 may be fixed to each other.

In addition, at least one sealing member 18 may be interposed between the manifold 12 and the body portion 11 to prevent fluid from leaking through a gap between the manifold 12 and the body portion 11. Thus, the configuration achieves an airtight coupling between the manifold 12 and the body portion 11.

However, a method of coupling between the manifold 12 and the body portion 11 is not limited to the above-described examples. The manifold 12 and the body portion 11 may be coupled to each other using any other method, such as welding or the like.

Alternatively, the manifold 12 and the body portion 11 may be integrally formed using injection molding or sintering molding. The case 10 may be formed as a single member having, for example, a substantially rectangular parallelepiped block shape. In this case, there is an advantage in that the above-described fastener 17, screw hole 17a, fastener hole 17b, sealing member 18, or the like may be omitted.

The manifold 12 may include a first flow path 20 and a second flow path 30 being independent of the first flow path 20. When the manifold 12 and the body portion 11 are separate members, the first flow path 20 and the second flow path 30 may respectively have a groove shape with one side open.

The first flow path 20 may communicate with a plurality of valve accommodation holes 13 that are disposed in one row and one sensor accommodation hole 14. The second flow path 30 may communicate with a plurality of valve accommodation holes 13 that are disposed in another row. For example, as illustrated in FIGS. 1 to 3, the first flow path 20 may have a substantially “L” shape and may communicate with seven valve accommodation holes 13 and one sensor accommodation hole 14. The second flow path 30 may have a substantially “I” shape and may communicate with the remaining six valve accommodation holes 13 disposed in the other row.

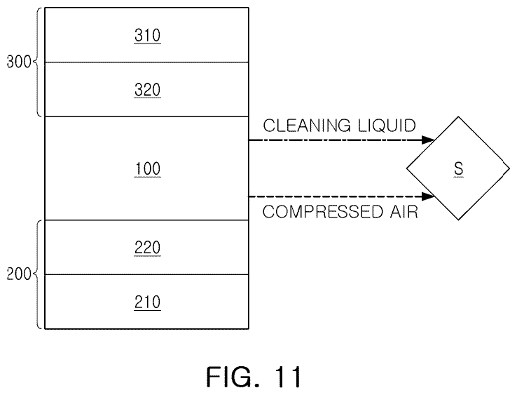

The first flow path 20 may have a first inlet 21, a plurality of first outlets 23, and a plurality of first valves 22 for a first fluid. The first fluid may be gas such as compressed air. When the first fluid is compressed air, the compressed air may be compressed by an air compressor 210 (see FIG. 11), stored in an air tank 220 (see FIG. 11), and then supplied to the first inlet 21, as necessary.

The first inlet 21 and the plurality of first outlets 23 may have a substantially tubular shape and extend from the manifold 12 to be parallel to the heightwise direction (Z-direction) of the body portion 11. Accordingly, the first fluid may flow in the heightwise direction (Z-direction) of the body portion within the first inlet 21 and the first outlets 23.

Any tube or pipe, not illustrated, may be connected to each of the first inlet 21 and the plurality of first outlets 23. The first inlet 21 and the plurality of first outlets 23 may include a flange 24 extending in a radially outward direction and formed along a circumferential direction. The flange may allow a tube or pipe to be easily connected to the first inlet 21 and each first outlet 23. The flange may allow the connected tube or pipe to be maintained on the first inlet 21 and each first outlet 23.

The first inlet 21 may further include an inlet valve 25 installed to control a flow of the first fluid within the first flow path 20 and to ensure airtightness.

The plurality of first outlets 23 may be connected to the first flow path 20 at a branch point. Each first outlet 23 may be selectively opened or closed by a corresponding first valve 22. Each first valve 22 may be configured to open or close a branch point of each first outlet 23 branching from the first flow path, so as to control the flow of the first fluid.

For example, a solenoid valve may be used as the inlet valve 25 and the plurality of first valves 22, but the present disclosure is not necessarily limited thereto.

Referring to FIGS. 2 and 4-9, the solenoid valve may have a plurality of first holes B and C disposed on an upper surface of a valve body A and a second hole D formed to protrude from the valve body A. The solenoid valve may have a valve flow path E, connecting the plurality of first holes (B,C) and the second hole D to each other within the valve body A. A plunger F may be moved by electromagnetic force generated when power is applied to the solenoid, thereby regulating the valve flow path E within the valve body A to open or close the valve and control a flow of fluid.

When the solenoid valve is used as the inlet valve 25 and the first fluid is compressed air, the plunger F may be arbitrarily moved by the pressure of the compressed air supplied through the first inlet 21 to allow the compressed air to flow. To prevent such an issue, selectively, a solenoid valve including a plunger F having increased spring force may be used as the solenoid valve for the inlet valve 21, as compared to another solenoid valve used for the first valve 22.

When such a solenoid valve is applied to the first flow path 20, at least one first hole B of the plurality of first holes B and C, disposed in an upper surface of the valve body A, may serve as an inlet. The second hole D, formed to protrude from the valve body A, and/or the remaining first hole C may serve as an outlet.

The first flow path 20 may connect the first inlet 21 and the plurality of first outlets 23 to each other. The first flow path 20 may extend within the manifold 12 to be parallel to the lengthwise direction (i.e., longitudinal direction or X-direction) of the body portion 11.

Accordingly, the first fluid, flowing into the first flow path 20 and filling the first flow path 20 through the first inlet 21 due to the opening of the inlet valve 25, may be selectively distributed by the plurality of first outlets 23 depending on the opening or closing of the plurality of first valves 22, and may flow out of the case 10.

Selectively, in the first flow path 20, a duct flow path 26 may be formed between the inlet valve 25 and the first valve 22 positioned upstream of the first flow path 20 (i.e., the first valve 22 is positioned downstream from the inlet valve 25), and an auxiliary tube 27 may be provided within the duct flow path 26. In order to form the duct flow path 26, the auxiliary tube 27 may be disposed in a mold for molding and be injection-molded. As a result, the auxiliary tube 27 may remain inserted into the duct flow path 26 after the duct flow path 26 is formed.

The auxiliary tube 27 may be helpful to molding the duct flow path 26 of the first flow path 20 in the manifold 12, and may have an inlet 27a and an outlet 27b having a predetermined diameter. As a result, the auxiliary tube 27 may serve to reliably transmit the pressure of the first fluid within the first inlet 21 to the plurality of first valves 22 and the first flow path 20.

When the solenoid valve is applied as the inlet valve 25, one first hole B of the plurality of first holes B and C, disposed in the upper surface of the valve body A, may be aligned with the first inlet 21 and positioned to be in communication with the first inlet 21. The second hole D, formed to protrude from the valve body A, may be aligned with an inlet 27a of the auxiliary tube 27 within the duct flow path 26 and positioned to be in communication with the inlet 27a.

In addition, when the solenoid valve is applied as the first valve 22, the plurality of first holes B and C, disposed in the upper surface of the valve body A, may be in communication with the first flow path 20. The second hole D, formed to protrude from the valve body A, may be aligned with a corresponding first outlet 23 and positioned to be in communication with the corresponding first outlet 23.

The second flow path 30 may have a second inlet 31, a plurality of second outlets 33, and a plurality of second valves 32 for a second fluid. The second fluid may be a liquid such as a cleaning liquid. When the second fluid is a cleaning liquid, the cleaning liquid may be stored in a cleaning liquid tank 310 (see FIG. 11) and then supplied to the second inlet by a pump 320 (see FIG. 11), as necessary.

The second inlet 31 may have a substantially tubular shape and extend from the manifold 12 to be parallel to the lengthwise direction (i.e., longitudinal direction or X-direction) of the body portion 11. Accordingly, the second fluid may flow in the lengthwise direction (i.e., longitudinal direction or X-direction) of the body portion within the second inlet 31.

The plurality of second outlets 33 may have a substantially tubular shape and extend from the manifold 12 to be parallel to the widthwise direction (i.e., lateral direction or Y-direction) of the body portion 11. Accordingly, the second fluid may flow in the widthwise direction (i.e., lateral direction or Y-direction) of the body portion 11 within the second outlets 33.

Any tube or pipe, not illustrated, may be connected to each of the second inlet 31 and the plurality of second outlets 33. The second inlet 31 and the plurality of second outlets 33 may include a flange 34 extending in a radially outward direction and formed along a circumferential direction. The flange 34 may allow a tube or pipe to be easily connected to the second inlet 31 and each second outlet 33. The flange 34 may also allow the connected tube or pipe to be maintained on the second inlet 31 and each second outlet 33.

The plurality of second outlets 33 may be connected to the second flow path 30 at a branch point. Each second outlet 33 may be selectively opened or closed by a corresponding second valve 32. Each second valve 32 may be configured to open or close a branch point of each second outlet 33 branching from the second flow path 30.

For example, the solenoid valve may be used as the plurality of second valves 32, but the present disclosure is not necessarily limited thereto. The inlet valve 25, the first valves 22, and the second valves 32 may have the same specifications and the same size, but the present disclosure is not necessarily limited thereto. The specifications of the inlet valve and the first and second valves may be unified as described above, thereby reducing the costs required for the integrated fluid distributor 100.

When the solenoid valve is applied as the same valve for the first valves 22 and the second valves 32, at least one first hole B of the plurality of first holes B and C, disposed in the upper surface of the valve body A, may serve as an inlet. The second hole D, formed to protrude from the valve body A, and/or the remaining first hole C of the plurality of first holes B and C may serve as an outlet.

In addition, when the solenoid valve is applied as the second valves 32, the plurality of first holes B and C, disposed in the upper surface of the valve body A, may be in communication with the second flow path 30. The second hole D, formed to protrude from the valve body A, may be positioned to be in communication with a corresponding second outlet 33.

The second flow path 30 may connect the second inlet 31 and the plurality of second outlets 33 to each other. The second flow path 30 may also extend within the manifold 12 to be parallel to the lengthwise direction (i.e., longitudinal direction or X-direction) of the body portion 11.

Accordingly, the second fluid, flowing into the second flow path 30 and filling the second flow path 30 through the second inlet 31, may be selectively distributed by the plurality of second outlets 33 depending on the opening or closing of the plurality of second valves 32, and may flow out of the case 10.

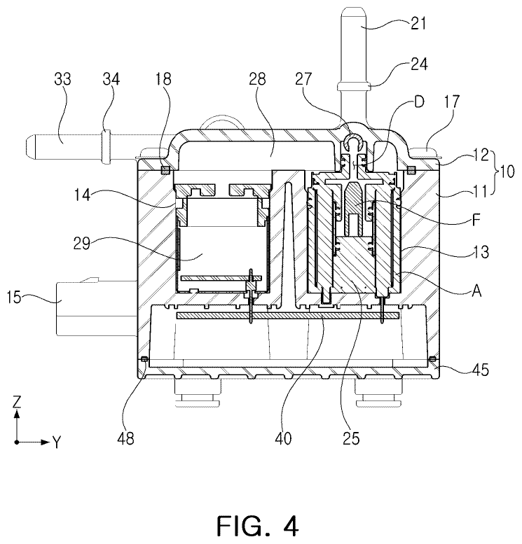

FIG. 4 is a cross-sectional view of the arrangement of a first valve 22 and a fluid sensor 29.

The first flow path 20 may include a sensing flow path 28 allowing the first inlet 21 and the sensor accommodation hole 14 to communicate with each other. The sensing flow path 28 may extend within the manifold 12 to be parallel to the widthwise direction (i.e., lateral direction or Y-direction) of the body portion 11. The sensing flow path 28 may allow the first fluid, flowing into the first inlet 21 from a fluid source such as a tank, to flow toward the fluid sensor 29, regardless of whether the inlet valve 25 is opened or closed.

For example, when a pressure sensor is inserted and accommodated, as the fluid sensor 29, in the sensor accommodation hole 14, the pressure sensor may measure the pressure of the first fluid flowing into the sensor accommodation hole 14 through the sensing flow path 28. A value of the measured pressure may be transmitted to the control board 40, to be described below, in the form of an electric signal.

As described above, the pressure sensor may be disposed in the sensing flow path 28 communicating with the first inlet 21. The pressure sensor may immediately measure the pressure of the first fluid flowing into the first inlet 21 and transmit a signal to the control board 40. Accordingly, feedback control for controlling a pumping means of the first fluid may be performed, thereby maintaining a constant pressure of the first fluid within the first flow path 20.

In addition, when the pressure sensor detects an abnormal pressure of the first fluid, the pressure sensor may transmit a signal to the control board 40, and the control board may drive the first valve 22 to relieve the overpressure.

In addition, due to the pressure sensor disposed in the sensing flow path 28 of the first flow path 20, the pressure sensor may not need to be added to a pipe or pumping means for supplying the first fluid.

Referring to FIGS. 2 and 4, the integrated fluid distributor 100 according to the first example embodiment of the present disclosure may further include a control board 40 disposed on the other side of the body portion 11. The control board 40 may be electrically connected to the fluid sensor 29, the inlet valve 25, the first valves 22, and the second valves 32 to receive information from the fluid sensor and to control the operation of the valves. The integrated fluid distributor 100 may also include a cover 45 coupled to the other side of the body portion 11 to protect the control board 40.

The control board 40 may be disposed in a space between the body portion 11 of the case 10 and the cover 45. For example, a printed circuit board may be used as the control board. In this case, a pattern circuit may be formed on one surface of the control board 40, and electronic parts such as resistors, condensers, and the like may be mounted on the one surface of the control board 40.

The pattern circuit of the control board 40 may include a connector terminal, such that a terminal of the fluid sensor 29 or terminals of the valves 22, 25, and 32 may be directly connected to the connector terminal or may be indirectly connected to the connector terminal via a conductor such as a wire or cable. In other words, the fluid sensor 29, the inlet valve 25, the first valves 22, and the second valves 32 may be electrically connected to the control board.

The cover 45 may be coupled to the body portion 11 of the case 10 by, for example, a fastening screw 47. To this end, a plurality of fastening holes 47b may be formed in the cover, and a screw hole 47a may be formed in a position corresponding to that of each fastening hole 47b in the body portion 11. The fastening screw 47 may pass through the cover 45 and be screwed into the screw hole 47a of the body portion 11, such that the cover 45 and the body portion 11 may be fixed to each other.

In addition, at least one sealing member 48 may be interposed between the cover 45 and the body portion 11, thereby preventing external moisture or foreign substances from entering a gap between the cover 45 and the body portion 11. Accordingly, the control board 40, disposed between the cover 45 and the body portion 11, may be protected.

The control board 40 may include various programmable processing units, such as a microprocessor embedded with a semiconductor chip or memory capable of performing various operations or commands. The processing unit may be programmed to command operation of the inlet valve 25, the first valves 22, and the second valves 32.

For example, the control board 40 may control the inlet valve 25 to operate independently. In addition, the control board may control the plurality of first valves 22 to operate independently or operate identically at the same time, while controlling the plurality of second valves 32 to operate independently or operate identically at the same time.

When the integrated fluid distributor 100 according to the first example embodiment of the present disclosure is applied to, for example, a cleaning system for a sensor S (see FIG. 11) installed in a vehicle, the control board 40 may be merged with or electrically connected to at least one of an integrated controller of the cleaning system or a high-level control system of the vehicle.

The control board 40 may further include a communication module, and may communicate a control signal related to operation of the valves 22, 25, and 32 or a signal output from the fluid sensor 29 with the integrated controller or the high-level control system. A communication module for short-range wireless communication using a controller area network (CAN) protocol may be used, but the present disclosure is not necessarily limited thereto, and a communication module for wired, wired/wireless, or optical communication may be applied.

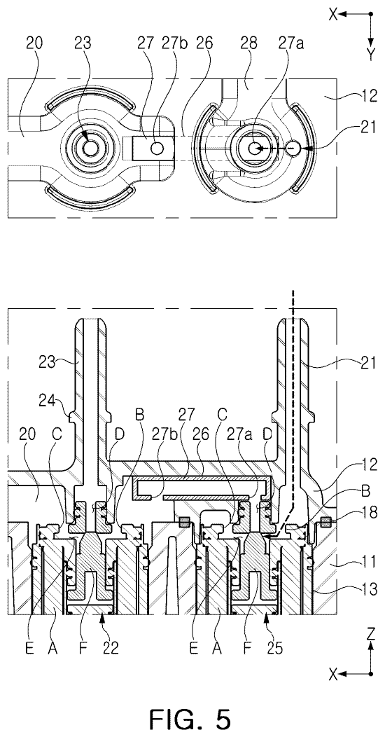

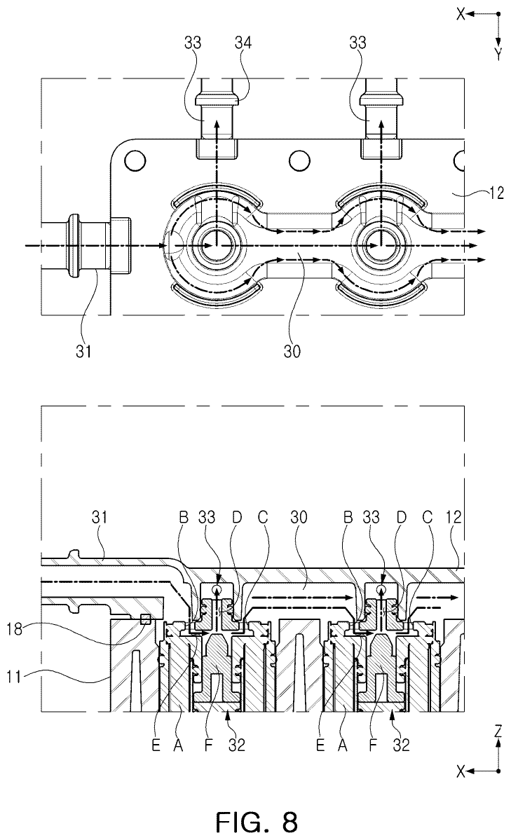

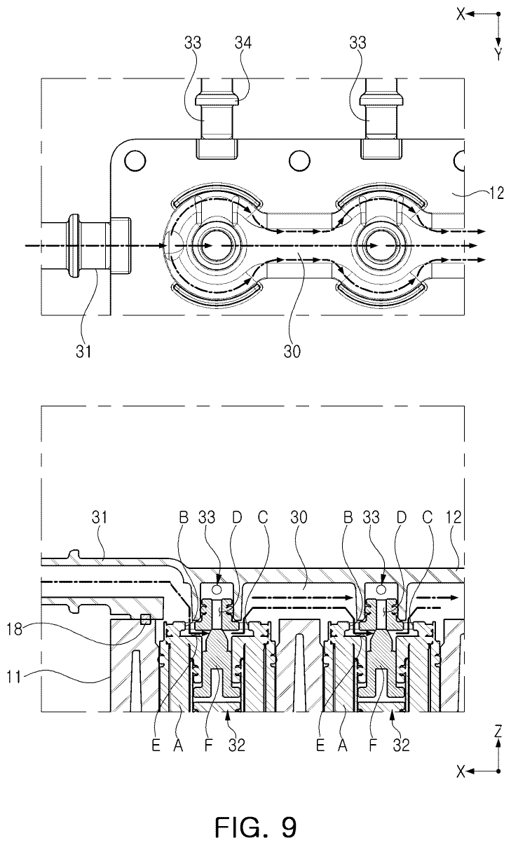

FIGS. 5 to 9 are diagrams illustrating operation of an integrated fluid distributor 100 according to the first example embodiment of the present disclosure. Each figure illustrates a transverse section and a longitudinal section. FIGS. 5 to 7 also illustrate a flow of the first fluid in the first flow path 20, and FIGS. 8 and 9 illustrate a flow of the second fluid in the second flow path 30.

In FIG. 5, the inlet valve 25 of the first inlet 21 may be closed. In this case, all of the plurality of first valves 22 of the first flow path 20 may be closed. As a result, the first fluid, flowing into the first inlet 21 from a fluid source such as a tank, may not flow through the first flow path 20.

However, the sensing flow path 28 may communicate with the first inlet 21 regardless of opening or closing of the inlet valve 25, such that the first fluid flowing into the first inlet 21 may flow toward the fluid sensor 29. For example, when the fluid sensor 29 accommodated in the sensor accommodation hole 14 is a pressure sensor, the pressure sensor may measure the pressure of the first fluid flowing into the sensor accommodation hole 14 through the sensing flow path 28.

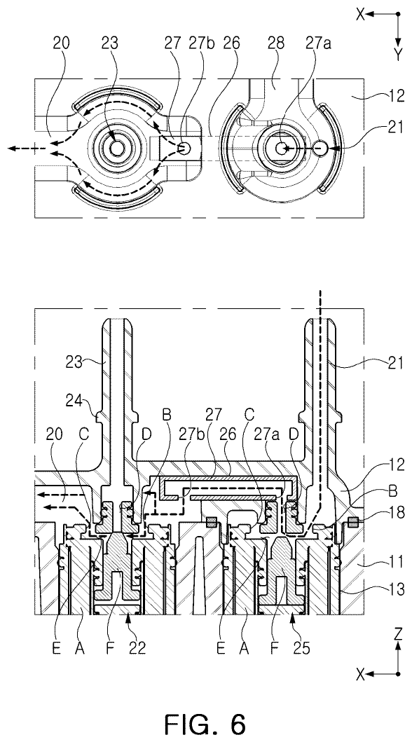

In FIG. 6, the inlet valve 25 of the first inlet 21 may be opened. In this case, the plurality of first valves 22 of the first flow path 20 may be individually operated and be opened or closed. FIG. 6 illustrates a first valve 22 positioned most upstream of the first flow path 20 (i.e., the first valve 22 is positioned downstream of the inlet valve 25) that is in a closed state.

For example, the first fluid, flowing into the first inlet 21 from a fluid source such as a tank, may pass through the inlet valve 25 and be discharged through the second hole D formed to protrude from the valve body A of the inlet valve 25. Subsequently, the first fluid may flow into the inlet 27a of the auxiliary tube 27 within the duct flow path 26, pass through the auxiliary tube 27, and be discharged to the outlet 27b. As a result, the first fluid may flow into the first flow path 20 and fill the first flow path 20.

In each first valve 22, the first fluid may flow into the valve body A through one first hold B of the plurality of first holes B and C, disposed in the upper surface of the valve body A. In the same manner as the first valve illustrated in FIG. 6, when the plunger F closes the second hole D, the first fluid may not flow to a corresponding first outlet 23, and thus may not be discharged. In this case, in order to release pressure within the first valve 22, the first fluid may flow out of the valve body A through the other one first hole C of the plurality of first holes B and C.

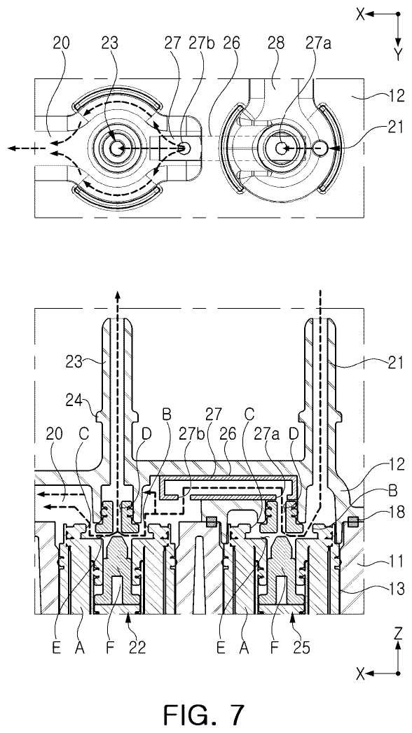

FIG. 7 illustrates the first valve 22 positioned most upstream of the first flow path 20. Specifically, FIG. 7 illustrates the first valve 22 being in an open state while the inlet valve 25 of the first inlet 21 is opened. The plunger F may open the second hole D within the first valve 22, such that the first fluid may flow out through the corresponding first outlet 23.

As the inlet valve 25 is opened, the first fluid, flowing into the first flow path 20 and filling the first flow path 20 through the first inlet 21, may be selectively distributed by the plurality of first outlets 23 depending on the opening or closing of the plurality of first valves 22, and may flow out of the case 10.

Each of the plurality of first valves 22 may independently operate regardless of the arrangement order thereof under the control of the control board 40 to open or close a desired first outlet 23. However, the present disclosure is not necessarily limited thereto. For example, the plurality of first valves 22 may be controlled to operate identically at the same time.

In FIG. 9, all of the second valves 32 of the second flow path 30 may be closed. However, for example, the second fluid, flowing into the second inlet 31 from a fluid source such as a tank, may flow into the second flow path and fill the second flow path.

In each second valve 32, the second fluid may flow into the valve body A through one first hole B of the plurality of first holes B and C, disposed in the upper surface of the valve body A. In the same manner as the second valve illustrated in FIG. 9, when the plunger F closes the second hole D, the second fluid may not flow to a corresponding second outlet 33, and thus may not be discharged. In this case, in order to release pressure within the second valve 32, the second fluid may flow out of the valve body A through the other one first hole C of the plurality of first holes B and C.

FIG. 8 illustrates an example in which the second valve 32 is opened. The plunger F may open the second hole D within the second valve 32, such that the second fluid may flow out through the corresponding second outlet 33.

The second fluid, flowing into the second flow path 30 and filling the second flow path 30 through the second inlet 31, may be selectively distributed by the plurality of second outlets 33 depending on the opening or closing of the plurality of second valves 32, and may flow out of the case 10.

Each of the plurality of second valves 32 may independently operate regardless of the arrangement order thereof under the control of the control board 40 to open or close a desired second outlet 33. However, the present disclosure is not necessarily limited thereto. For example, the plurality of second valves 32 may be controlled to operate identically at the same time.

In addition, the plurality of first valves 22 and the plurality of second valves 32 may be opened and closed independently of each other. Specifically, each first valve 22 may operate independently to open or close a desired first outlet 23 regardless of the opening or closing of each second valve 32, and vice versa.

Accordingly, in the integrated fluid distributor 100 according to the first example embodiment of the present disclosure, the first flow path 20 and the second flow path 30 for different fluids may be disposed independently of each other to form individual flow paths. Respective flow paths may independently distribute and discharge corresponding fluids.

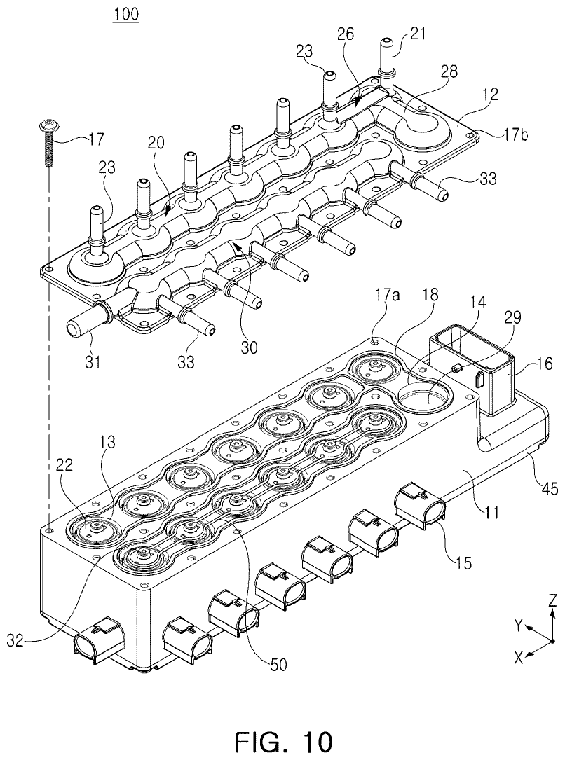

FIG. 10 is an exploded perspective view of an integrated fluid distributor 100 according to a second example embodiment of the present disclosure. FIG. 10 illustrates a body portion 11 and a manifold 12 of a case 10 separately from each other.

An integrated fluid distributor 100 according to a second example embodiment of the present disclosure may include a case 10, a first flow path 20, a second flow path 30, and a heating member 50.

The second example embodiment illustrated in FIG. 10 may be different from the first example embodiment only in that the heating member 50 is added. Additionally, the second example embodiment may be the same as the first example embodiment in terms of the remaining components. Accordingly, in describing the integrated fluid distributor 100 according to the second example embodiment, components that may be the same as the components of the above-described integrated fluid distributor according to the first example embodiment may be denoted by the same reference numerals, and detailed descriptions of configurations and functions of the components have been omitted.

The heating member 50 may be disposed in at least one of the first flow path 20 and the second flow path 30. When a manifold 12 and a body portion 11 of the case 10 are separate members, the heating member 50 may be installed on an upper surface of the body portion 11 to be placed across a plurality of valve accommodation holes 13 or to surround the plurality of valve accommodation holes 13. Alternatively, the heating member 50 may be installed to be accommodated in the first flow path 20 or the second flow path 30 in the manifold 12.

FIG. 10 illustrates an example in which a single heating member 50 is placed across a plurality of valve accommodation holes 13 in a position corresponding to that of the second flow path 30, on an upper surface of the body portion 11. However, the arrangement of the heating member 50 is not necessarily limited thereto, and the heating member 50 may be accommodated in the first flow path 20 or the second flow path 30 to be in contact with a first fluid or a second fluid. Additionally, the heating member 50 may transfer generated heat to a corresponding fluid.

The heating member 50 may include a heating wire. The heating wire may be connected to a connector terminal of a control board 40 via a conductor such as a wire or cable. The heating wire may receive a predetermined power source r from the control board, and accordingly current may flow therethrough. As current flows therethrough, heat generated due to internal electrical resistance of the heating wire itself may be externally released.

For example, when the integrated fluid distributor 100 according to the present disclosure is applied to a cleaning system for a sensor S installed in a vehicle and a liquid such as a cleaning liquid is used as the second fluid, there is a limitation in that it is not possible to perform cleaning with a cleaning liquid at room temperature.

According to the integrated fluid distributor 100 according to the second example embodiment of the present disclosure, the cleaning liquid may be heated to, for example, 60° C. or higher using the heating member 50 including the heating wire. As a result, the configuration improves the cleaning power of the cleaning liquid without using a toxic cleaning liquid.

FIG. 11 is a schematic diagram illustrating an example of a cleaning system for a vehicle sensor to which an integrated fluid distributor is applied according to example embodiments of the present disclosure.

An integrated fluid distributor 100 according to example embodiments of the present disclosure may be applied to a cleaning system for a vehicle sensor S. For example, a cleaning system may include an air supply module 200, a cleaning liquid supply module 300, and an integrated fluid distributor 100.

The air supply module 200 may include an air compressor 210 and an air tank 220. The air supply module 200 may have a structure in which the air compressor and the air tank are integrated to form a single module or a single assembly. The air supply module 200 may generate and store compressed air and supply the compressed air to the integrated fluid distributor 100.

The compressed air, stored in the air tank 220 of the air supply module 200, may be supplied to the integrated fluid distributor 100. The compressed air may be distributed, for example, through a first flow path 20 of the integrated fluid distributor 100, and thus may be sprayed toward various sensors S included in a vehicle and used for cleaning.

The cleaning liquid supply module 300 may include a cleaning liquid tank 310 and a pump 320. For example, the pump 320 may be coupled to an upper portion of the cleaning liquid tank 310, and at least a portion of the pump 320 may be accommodated in the cleaning liquid tank 310. The cleaning liquid tank 310 may store a cleaning liquid therein, and the pump 320 may supply the cleaning liquid, stored in the cleaning liquid tank 310, to the integrated fluid distributor 100.

The cleaning liquid, stored in the cleaning liquid tank 310 of the cleaning liquid supply module 300, may be supplied to the integrated fluid distributor 100 through the pump 320. The cleaning liquid may then be distributed, for example, through a second flow path 30 of the integrated fluid distributor 100, and thus may be sprayed toward the various sensors S included in the vehicle and used for cleaning.

The integrated fluid distributor 100 may be connected together to the air supply module 200 and the cleaning liquid supply module 300. The integrated fluid distributor 100 may distribute compressed air supplied from the air supply module 200 and a cleaning liquid supplied from the cleaning liquid supply module 300 to a plurality of nozzles (not illustrated) positioned in a plurality of vehicle sensors S. The compressed air and/or the cleaning liquid may be respectively sprayed to the plurality of vehicle sensors through the plurality of nozzles.

The integrated fluid distributor 100 may perform only one of distribution of the compressed air and distribution of the cleaning liquid or both distribution of the compressed air and distribution of the cleaning liquid. In addition, the integrated fluid distributor 100 may perform the distribution of compressed air and the distribution of cleaning liquid simultaneously or alternately.

According to the integrated fluid distributor 100 according to example embodiments of the present disclosure, a distributor for distributing compressed air and a distributor for distributing a cleaning liquid may be integrated into a single distributor, such that compressed air and cleaning liquid may be independently distributed through a single integrated fluid distributor 100 without an additional distributor, thereby simplifying a configuration of the cleaning system.

For example, the integrated fluid distributor 100 may form a module integrated with or an assembly assembled integrally with at least one of the air supply module 200 and the cleaning liquid supply module 300. Thus, the cleaning system may include one module or two modules.

The modularized cleaning system may be installed within the vehicle. The modularized cleaning system may clean a vehicle sensor by spraying at least one of compressed air and a cleaning liquid through pipes extending to various sensors S disposed inside and outside the vehicle.

According to example embodiments of the present disclosure, flow paths for different fluids may be independently disposed in a single distributor, thereby reducing the number of parts, as compared to distributors configured for each flow path, and reducing the possibility of leakage and energy loss due to a simplified pipe.

In addition, according to example embodiments of the present disclosure, a configuration of a distributor in which flow paths for fluids are integrated may allow the number of modules within an application system to be optimized and may reduce a layout, a volume, and a weight of the system, as well as costs. As a result, the configuration may increase product competitiveness.

While embodiments have been shown and described above, it should be apparent to those having ordinary skill in the art that modifications and variations could be made without departing from the scope of the present disclosure as defined by the appended claims.

What is claimed is:

1. An integrated fluid distributor comprising:
a case;
a first flow path disposed within the case, the first flow path having a first inlet, a plurality of first outlets, and a plurality of first valves for a first fluid; and
a second flow path disposed independently of the first flow path within the case, the second flow path having a second inlet, a plurality of second outlets, and a plurality of second valves for a second fluid.

2. The integrated fluid distributor of claim 1, wherein
each first valve is configured to open and close a branch point of each first outlet branching from the first flow path, and
each second valve is configured to open and close a branch point of each second outlet branching from the second flow path.

3. The integrated fluid distributor of claim 1, wherein
the case includes a body portion accommodating the plurality of first valves and the plurality of second valves, and a manifold coupled to one side of the body portion, and
the first flow path and the second flow path are formed in the manifold.

4. The integrated fluid distributor of claim 3, wherein
the body portion has a plurality of valve accommodation holes arranged in two rows in a lengthwise direction of the body portion,
the plurality of valve accommodation holes in one row respectively accommodate the plurality of first valves and communicate with the first flow path, and
the plurality of valve accommodation holes in another row respectively accommodate the plurality of second valves and communicate with the second flow path.

5. The integrated fluid distributor of claim 3, wherein
the first inlet and the plurality of first outlets extend from the manifold to be parallel to a heightwise direction of the body portion,
the second inlet extends from the manifold to be parallel to a lengthwise direction of the body portion, and
the plurality of second outlets extend from the manifold to be parallel to a widthwise direction of the body portion.

6. The integrated fluid distributor of claim 3, wherein the first inlet further includes an inlet valve configured to control a flow of the first fluid within the first flow path.

7. The integrated fluid distributor of claim 6, wherein the inlet valve, the plurality of first valves, and the plurality of second valves are solenoid valves having the same configuration.

8. The integrated fluid distributor of claim 7, wherein each solenoid valve includes:
a valve body;
a plurality of first holes disposed in one side of the valve body;
a second hole formed to protrude from the one side of the valve body;
a valve flow path formed within the valve body, the valve flow path configured to fluidly connect the plurality of first holes and the second hole to each other; and
a plunger configured to move by electromagnetic force generated when power is applied,
wherein the plunger is configured to regulate the valve flow path.

9. The integrated fluid distributor of claim 8, wherein, in the first flow path, a duct flow path is formed between the inlet valve and a first valve positioned upstream of the first flow path, and an auxiliary tube is provided within the duct flow path.

10. The integrated fluid distributor of claim 9, wherein when the inlet valve is the solenoid valve, one of the plurality of first holes is aligned with the first inlet and is configured to be in fluid communication with the first inlet, and the second hole is aligned with an inlet of the auxiliary tube and is configured to be in fluid communication with the inlet.

11. The integrated fluid distributor of claim 8, wherein when the plurality of first valves are solenoid valves, the plurality of first holes of each solenoid valve are configured to be in fluid communication with the first flow path, and the second hole of each solenoid valve is aligned with each first outlet and is configured to be in fluid communication with each first outlet.

12. The integrated fluid distributor of claim 8, wherein when the plurality of second valves are solenoid valves, the plurality of first holes of each solenoid valve are configured to be in fluid communication with the second flow path, and the second hole of each solenoid valve is configured to be in fluid communication with each second outlet.

13. The integrated fluid distributor of claim 6, wherein
the body portion has a sensor accommodation hole disposed in one side thereof, and
at least one fluid sensor is accommodated in the sensor accommodation hole.

14. The integrated fluid distributor of claim 13, wherein the first flow path includes a sensing flow path configured to allow the first inlet and the sensor accommodation hole to communicate with each other.

15. The integrated fluid distributor of claim 14, wherein
the fluid sensor is a pressure sensor, and
the pressure sensor measures a pressure of the first fluid flowing into the sensor accommodation hole through the sensing flow path.

16. The integrated fluid distributor of claim 13, further comprising:
a control board disposed on the body portion, the control board is electrically connected to the fluid sensor, the inlet valve, the plurality of first valves, and the plurality of second valves to receive information from the fluid sensor and to control operation of the inlet valve, the plurality of first valves, and the plurality of second valves.

17. The integrated fluid distributor of claim 3, further comprising:
a heating member disposed in at least one of the first flow path and the second flow path,
wherein the heating member includes a heating wire.

18. The integrated fluid distributor of claim 1, wherein
the integrated fluid distributor is applied to a cleaning system for cleaning a vehicle sensor mounted on a vehicle,
the cleaning system includes an air supply module configured to supply compressed air, and a cleaning liquid supply module configured to supply a cleaning liquid, and
the integrated fluid distributor is configured to be in fluid connection with the air supply module and the cleaning liquid supply module.

19. The integrated fluid distributor of claim 18, wherein
the air supply module includes an air compressor configured to generate compressed air, and an air tank configured to store the compressed air,
the cleaning liquid supply module includes a cleaning liquid tank configured to store a cleaning liquid, and a pump configured to supply the cleaning liquid stored in the cleaning liquid tank to the integrated fluid distributor,
the air tank is configured to be in fluid connection with the first inlet, such that compressed air, a first fluid, or a combination thereof are distributed in the first flow path, and
the pump is configured to be in fluid connection with the second inlet, such that a cleaning liquid, a second fluid, or a combination thereof are distributed in the second flow path.

20. The integrated fluid distributor of claim 18, wherein the integrated fluid distributor forms a module integrated with or an assembly integrally assembled with at least one of the air supply module and the cleaning liquid supply module.
